(19) United States
(12) Patent Application Publication
(10) Pub. No.: US 2016/0348620 A1
(43) Pub. Date: Dec. 1, 2016

(54) ASSEMBLY INCLUDING A HEAT ENGINE AND AN ELECTRIC COMPRESSOR CONFIGURED TO HEAT THE AIR-FUEL MIXTURE

(71) Applicant: VALEO SYSTEMES DE CONTROLE MOTEUR, Cergy Saint Christophe (FR)

(72) Inventors: Aurélien RAMSEYER, Boulogne-Billancourt (FR); Philippe LUTZ, Le Vesinet (FR); Julien MARCINKOWSKI, Sartrouville (FR); Matthew WEBSTER, Brentwood (GB)

(73) Assignee: Valeo Systemes de Controle Moteur, Cergy Saint Christophe (FR)

(21) Appl. No.: 15/106,493

(22) PCT Filed: Dec. 18, 2014
(86) PCT No.: PCT/FR2014/053417

§ 371 Date: Aug. 23, 2016

(30) Foreign Application Priority Data
Dec. 19, 2013 (FR) 1363113

(51) Int. Cl. F02M 35/10; F02B 33/40; F02B 39/10

(52) U.S. Cl. CPC F02M 35/10268; F02B 39/10; F02B 33/40; F02M 35/10157

(57) ABSTRACT

The present invention relates to an assembly (1) which includes: an inlet pipe (4) extending between an air inlet (11) and a heat engine (2), a heat engine (2), and an electric compressor (5) arranged on the inlet pipe, the electric compressor (5) being configured such as to enable the inlet gases flowing in the inlet pipe (4) to be heated.

The present invention relates to the field of heating the air-fuel mixture of a heat engine, and, more particularly, to an assembly including a heat engine and an electric compressor configured to heat the air-fuel mixture.

The present invention relates to all the gasoline, diesel, gas, ethanol heat engines, whether they are supercharged or not.

There are phases in the life of the vehicle in which it is advantageous to heat the air-fuel mixture. This pertains particularly to cold starts, when the engine itself is cold, and the temperature of the intake air is low. Indeed, in this case, the combustion is slowed and generates more polluting emissions, in particular more unburnt HC and CO type compounds, and particles. This is truer the lower the outside temperature is.

Currently, for heating or reheating the air-fuel mixture, electric systems for heating the air-fuel mixture are considered, taking into account future pollution reduction measures under the Euro 6 standard and beyond. They involve, for example, resistors placed directly in the air intake pipes. This solution by electric reheating is effective but has two disadvantages:

it is used only for reheating the air-fuel mixture. The cost of the system is therefore difficult to recover, since its usefulness is limited only to cold starts, for a duration of several tens of seconds.

it is intrusive: it is necessary to find a solution in which the electrical resistance is built-in, and to manage the sealing of the air circuit.

In the case of supercharged engines, a system for cooling the air-fuel mixture is needed for the hot operation of the engine, in order to increase the mass of air taken into the engine. This system is counterproductive during cold starts, when the objective is, on the contrary, to increase the temperature of the air-fuel mixture. In order to avoid the cooling, systems for bypassing this exchanger exist. However, although this system avoids the cooling of the air-fuel mixture, it does not make it possible to reheat it.

Thus, the subject matter of the present invention is to overcome one or more of the disadvantages of the system for reheating the air-fuel mixture of the prior art by proposing a system for heating the air-fuel mixture for a heat engine, which is provided with an electric compressor, that does not require the installation of an additional device for this purpose alone.

To achieve this, the present invention proposes an assembly including:

an intake pipe extending between an air inlet and a heat engine,

a heat engine,

an electric compressor arranged on the intake pipe, the electric compressor being configured to make it possible to heat the air-fuel mixture circulating in the intake pipe.

According to an embodiment of the invention, the electric compressor is provided with a variable reluctance motor.

According to an embodiment of the invention, the assembly according to the invention includes at least one valve arranged upstream of a heat engine and downstream or upstream of the electric compressor, which regulates the flow rate of the air-fuel mixture in the heat engine.

According to an embodiment of the invention, the electric compressor is built into a first bypass circuit comprising a first bypass means configured so as to allow the recirculation of a portion of the air-fuel mixture coming from the electric compressor through said electric compressor during the heating of the air-fuel mixture.

According to an embodiment of the invention, the assembly according to the invention includes a heat exchanger arranged on the intake pipe.

According to an embodiment of the invention, the heat exchanger is built into a second bypass circuit comprising a second bypass means configured so that the air-fuel mixture does not pass through the heat exchanger during the heating of the air-fuel mixture.

According to an embodiment of the invention, the electric compressor is arranged upstream of the heat exchanger and downstream of the valve.

According to another embodiment of the invention, the electric compressor is arranged downstream of the heat exchanger and upstream of the valve.

The present invention also relates to a method for heating the air-fuel mixture using the assembly according to the invention, including:
a step of activation of the electric compressor,
a step of circulation of the air-fuel mixture through the electric compressor,
a step of regulating the flow rate of the air-fuel mixture with a valve.

According to an embodiment of the invention, the method according to includes a second step of circulation of the air-fuel mixture through the electric compressor.

The present invention also relates to the use of the assembly according to the invention for heating the air-fuel mixture during a start phase.

The present invention also relates to the use of the assembly according to the invention for heating the intake pipe during a phase preceding the start.

Other purposes, features, and advantages of the invention will be understood better and become clearer upon reading the description given below in reference to the appended drawings given as examples and in which:

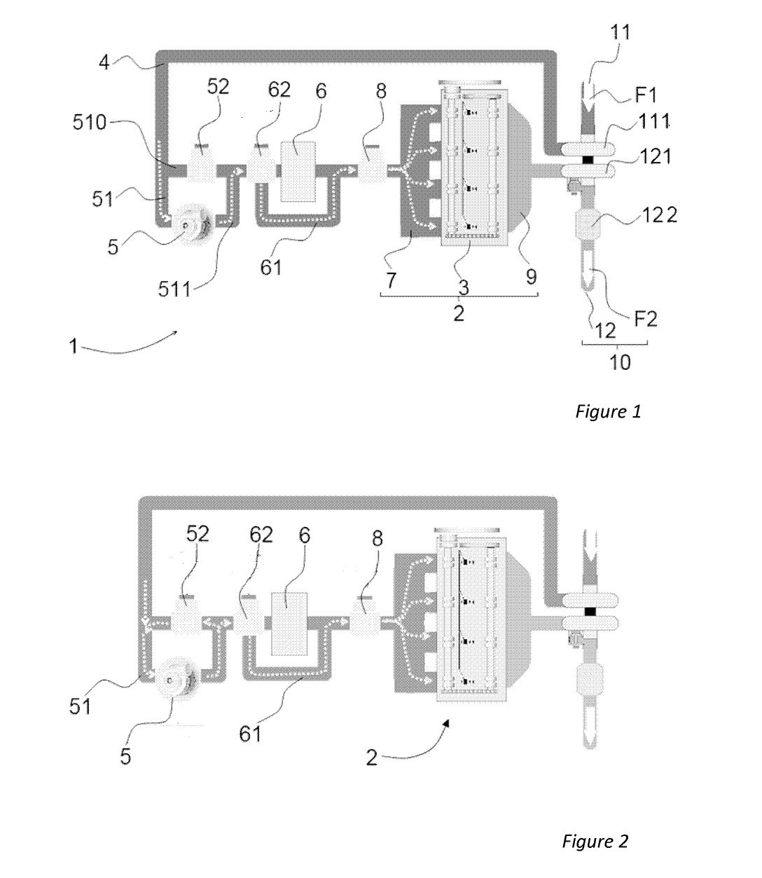

FIG. 1 is a diagrammatic representation of a first mode of operation of the device according to the invention,

FIG. 2 is a diagrammatic representation of a second mode of operation of the device according to the invention.

The present invention relates to a heat engine provided with an electric compressor used for heating the air-fuel mixture during the start phase or during the phase preceding the start.

In the remainder of the description, electric compressor is understood to mean an air compressor that is volumetric or non-volumetric, centrifugal or radial, for example, driven by an electric motor, for the purpose of supercharging a heat engine.

According to an embodiment of the invention, the compressor is an air supercharging compressor.

According to an embodiment of the invention, the electric motor of the electric compressor is a synchronous, direct current or alternating current motor, or any type of electric motor of the same type.

More precisely, according to an embodiment of the invention, the electric motor is a variable reluctance motor (also referred to as SRM machine for Switched Reluctance Motor according to the English terminology).

The supercharging makes it possible to keep the performances of an engine while reducing the cylinder capacity (downsizing according to the English terminology). For a given torque to be provided, the charging is then greater, which generally leads to a better yield and to a reduced fuel consumption. An electric compressor is used alone or in addition to a turbo-compressor for the purpose of reducing the response time thereof. Full power operation of the engine can thus be reached more rapidly, which makes it possible to further reduce the cylinder capacity for the purpose of reducing the average consumption during conventional use of the engine.

The electric compressor is thus generally activated in order to increase the density of the air taken in. The increase in the density is necessarily accompanied by an increase in temperature. In the context of the invention, it is this increase in temperature that is sought. More precisely, the electric compressor is used directly for heating the air-fuel mixture.

In the context of the invention, start phase is understood to mean the phase during which the engine is started.

In the case of the start phase of the engine, the electric compressor makes it possible at least to heat the air-fuel mixture. According to an embodiment, the electric compressor makes it possible at least to heat the intake pipe and the air-fuel mixture.

In the context of the invention, phase preceding the start is understood to mean the phase preceding the starting of the engine.

In the case of the phase preceding the starting of the engine, the electric compressor makes it possible at least to heat the intake pipe.

The engine assembly 1 to which the present invention relates, an embodiment of which is illustrated in FIGS. 1 and 2 with the intake pipe 4 of the intake circuit, includes an internal combustion heat engine 2 of an automobile and an electric compressor 5.

This engine 2 comprises a combustion chamber 3 comprising a plurality of cylinders, four in the figures, which is intended to receive a mixture of oxidizer and fuel, and, for example, the gasoline or diesel as fuel and pure air or an air/recirculation gas mixture as oxidizer.

The combustion in the cylinders generates the work of the engine 2. The operation of the engine 2 is conventional: the air-fuel mixture is introduced into the combustion chamber 3, compressed therein, burnt and then expelled in the form of exhaust gases.

This engine 2 has an inlet connected to the intake pipe 4 and an outlet connected to a gas exhaust circuit 10.

The inlet 11 of the intake pipe 4 defines the inlet through which the fresh air enters the assembly 1, while the outlet 12 of the exhaust circuit 10 defines the outlet through which the exhaust gases are discharged from the assembly 1.

The intake pipe 4 leads to an intake manifold 7, which thus forms an inlet box for the air-fuel mixture leading into the combustion chamber 3 of the engine 2.

Intake pipe 4 is understood to mean the intake channel for the air-fuel mixture, the flow of which is represented by the arrow F1, this pipe being located between the air inlet I1 and the engine 2.

According to an embodiment of the invention, the intake pipe 4 comprises a mechanical compressor 111 for the air-fuel mixture, which is, for example, a turbo-compressor.

According to an embodiment of the invention, the intake pipe 4 comprises a heat exchanger 6, enabling the cooling of the air-fuel mixture, and, for example, of the air-fuel mixture coming from the mechanical compressor 111. This heat exchanger 6, also referred to as “SAC” by the person skilled in the art, which stands for “supercharging air cooler,” has the function of cooling the air-fuel mixture. The heat exchanger 6 ensures a thermal exchange between the air-fuel mixture and the heat transfer fluid of the heat exchanger 6. At the outlet of the heat exchanger 6, the air-fuel mixture is at a temperature close to that of the heat transfer fluid of the heating exchanger 6.

According to an embodiment of the invention, upstream of the intake manifold 7 for intake of the air-fuel mixture into the engine 2, the intake pipe 4 comprises a valve 8 comprising a shutter of the butterfly valve type, the function of which is to regulate the air-fuel mixture flow rate for the regulation of the engine rpm. This valve 8 is controlled by an engine control unit (also referred to as ECU using the English terminology), which is well known to the person skilled in the art and which makes it possible to regulate the quantity of air introduced into the engine. In the context of the invention, when the electric compressor is used for the purpose of reheating the air-fuel mixture, this valve 8 is more closed than if the electric compressor were inactive, as a result of which the quantity of air taken in is always the same, but the air is taken in at a higher temperature.

According to an embodiment of the invention, the butterfly valve 8 is upstream of the electric compressor 5.

According to an embodiment of the invention, the butterfly valve 8 is downstream of the electric compressor 5.

The outlet of the engine 2 is formed by an exhaust gas manifold 9. The latter is connected to an exhaust channel 124 for the gases, which is part of the gas exhaust circuit.

According to an embodiment of the invention, the exhaust circuit 10 comprises a turbine 121, which is rotatably connected to the mechanical compressor 111 for the air-fuel mixture, forming a turbo-compressor with this mechanical compressor. The turbine 121 is driven by the exhaust gases of the exhaust channel 124, the flow of which is represented diagrammatically by the arrow F2. According to an embodiment, the flow passes through the catalyst 122.

According to an embodiment, the assembly 1 includes a return loop, not illustrated, which enables all or some of the exhaust gases circulating in the exhaust circuit 10 to be reinjected into the engine 2. The return loop includes an outlet leading to the intake pipe 4 and through which exhaust gases are reinjected upstream of the engine 2.

As illustrated in FIG. 1, the assembly 1 includes an electric compressor 5. This compressor 5 is driven by an electrical motor, not shown, which is controlled, for example, by the engine control unit. The electric compressor 5 is arranged in the loop of the intake pipe 4.

In a first variant of the invention, the electric compressor 5 is arranged upstream of the heat exchanger 6, and the air-fuel mixture coming from the heat exchanger 6 comes out upstream of the butterfly valve 8 and is then led into the intake manifold 7.

According to another variant of the invention, the electric compressor 5 is arranged upstream of the butterfly valve 8, and the air-fuel mixture coming from the electric compressor 5 circulating through the valve is then led into the intake manifold 7.

According to another variant of the invention, the electric compressor 5 is arranged upstream of the mechanical compressor 111.

According to an embodiment of this variant, the electric compressor 5 is arranged upstream of the butterfly valve 8, between the heat exchanger 6 and the butterfly valve 8.

According to another variant of the invention, the electric compressor 5 is arranged downstream of the butterfly valve 8.

According to an embodiment of the invention, the electric compressor 5 is built into a first bypass circuit 51 (also referred to as bypass circuit according to the English terminology) comprising a first bypass means 52 of the valve type. The electric compressor can also be short-circuited by this bypass system. This first bypass valve 52 is, for example, a butterfly valve. This first bypass valve 52 is, for example, controlled by the engine control unit. The first bypass circuit 51 associated with the first bypass means 52, in general, enables the air-fuel mixture arriving via the intake circuit 4 to circulate through the electric compressor or to circumvent it, due to the closing or opening of the first bypass means 52. The first bypass means 52 of the valve type is arranged on a first pipe 510 of the bypass circuit 51, which is different from that of the electric compressor 5, so that, when the bypass valve 52 is closed, the air-fuel mixture is directed towards the second pipe 511 where the electric compressor 5 is arranged.

Thus, outside of the start phases, or, in general, outside of the phases that do not require the use of the electric compressor 5, the air-fuel mixture circulates in the first pipe 510 and does not flow through the electric compressor 5.

According to an embodiment of the invention, when the bypass valve 52 is open, the air-fuel mixture circulates in the first pipe 510 and through the electric compressor.

According to an embodiment, the heat exchanger 6 is built into a second bypass circuit 61 comprising a second bypass means 62 of the valve type. In the same way as for the first bypass circuit 51 of the electric compressor, the second bypass circuit 61 associated with the second bypass means 62 allows the air-fuel mixture to pass through the heat exchanger 6 or to circumvent it, due to the closing or opening of the second bypass means 62.

According to an embodiment of the invention, the first bypass means 61 and the second bypass means 62 are formed by one and the same valve arranged between the two bypass circuits 51, 61.

The invention thus relates to the presence of the electric compressor associated with at least one valve arranged upstream of the inlet of the engine 2. This means that the electric compressor heats the air-fuel mixture and compresses it, and the flow rate of this heated and compressed air-fuel mixture is regulated by a valve.

The temperature of the air taken in does not vary between the outlet of the electric compressor 5 and the inlet into the engine 2. Does not vary is understood to refer to the fact that the temperature is identical plus or minus a few degrees, that is to say the degrees lost during its circulation between the electric compressor and the inlet of the engine.

The operation of the assembly according to the invention is as follows.

During a start phase or a phase preceding the starting, the air-fuel mixture arrives via the intake pipe 4, is directed to the bypass circuit 51 by means of the valve 52, and flows through the electric compressor. In this configuration, the valve 52 of the electric compressor 5 is in a closed position, and the air-fuel mixture thus has to flow through the compressor. The compressor is then activated via the control unit.

At this time, the bypass means 52 of the valve type is controlled so as to direct the air-fuel mixture to the electric compressor 5. The air-fuel mixture flows through the electric compressor 5 and comes out of it heated. In this configuration, the increase in temperature is by at least 10° C. or more.

According to the first variant of the invention, the air-fuel mixture thus heated by the electric compressor 5 then passes into the second bypass circuit 61 of the heat exchanger 6 by means of the second bypass means 62, which is in a position that does not allow the passage of the air-fuel mixture into the heat exchanger 6. Thus, the air-fuel mixture heated by the electric compressor then arrives directly upstream of the valve 8 comprising a shutter 8 of the butterfly valve type. The valve 8 is configured to allow the passage, into the intake manifold 7, of the amount of air-fuel mixture needed for the combustion.

According to the second embodiment variant of the invention, the air-fuel mixture thus heated by the electric compressor 5 arrives directly upstream of the valve 8 comprising a shutter of the butterfly valve type. The valve 8 is configured to allow the passage, into the intake manifold 7, of the amount of gas needed for the combustion.

According to an embodiment of the invention, the electric compressor 5 can be activated when the bypass means 52 is open, so that a portion of the flow reheated by and coming from the compressor 5 and circulating in the branch 511 flows through the bypass means 52 in the opposite direction from its normal operation and is mixed with the fresh air entering the compressor 5.

This recirculation makes it possible to increase the flow that passes through the electric compressor 5, which makes it possible to avoid the pumping phenomenon which is well known to the person skilled in the art and which has a destructive effect in the case of the centrifugal and radial compressors. With this increased pumping margin, it is possible to reheat the air-fuel mixture even more, resulting in an even higher temperature of the air-fuel mixture taken in by the engine. In this configuration, the increase in temperature is by 50° C. or more.

The air-fuel mixture thus heated arrives at the butterfly valve 8. The valve is configured so as to allow the passage of a sufficient quantity of heated air-fuel mixture for the operation of the engine (2).

The scope of the present invention is not limited to the details given above and allows embodiments in numerous other specific forms without diverging from the field of application of the invention. Consequently, the present embodiments have to be considered illustrations and can be modified without however exceeding the scope defined by the claims.

1. An assembly comprising:
an intake pipe extending between an air inlet and a heat engine;
the heat engine; and
an electric compressor arranged on the intake pipe,
the electric compressor being configured to facilitating heating of an air-fuel mixture circulating in the intake pipe.

2. The assembly according to claim 1, further comprising at least one valve arranged upstream of the heat engine and upstream or downstream of the electric compressor that regulates the flow rate of the air-fuel mixture in the heat engine.

3. The assembly according to claim 1, wherein the electric compressor is built into a first bypass circuit comprising a first bypass means configured to enable the recirculation of a portion of the air-fuel mixture coming from the electric compressor through said electric compressor during the heating of the air-fuel mixture.

4. The assembly according to claim 1, including a heat exchanger arranged on the intake pipe.

5. The assembly according to claim 4, wherein the heat exchanger is built into a second bypass circuit comprising a second bypass means configured so that the air-fuel mixture does not pass through the heat exchanger during the heating of the air-fuel mixture.

6. The assembly according to claim 4, wherein the electric compressor is arranged upstream of the heat exchanger and downstream of the valve.

7. The assembly according to claim 4, wherein the electric compressor is arranged downstream of the heat exchanger and upstream of the valve.

8. The assembly according to claim 1, wherein the electric compressor is provided with a variable reluctance motor.

9. A method for heating the air-fuel mixture using the assembly according to claim 1, including:
activation of the electric compressor;
circulation of the air-fuel mixture through the electric compressor; and
regulating the flow rate of the air-fuel mixture with a valve.

10. The method according to claim 9, further comprising a second circulation of the air-fuel mixture through the electric compressor.

11. A use of the assembly according to claim 1, for heating the air-fuel mixture during a start phase.

12. A use of the assembly according to claim 1, for heating the intake pipe during a phase preceding the start.
